(19) United States
(12) Patent Application Publication
(10) Pub. No.: US 2026/0003969 A1
(43) Pub. Date: Jan. 1, 2026

(54) PREDICTED CHANGE REQUEST OUTCOMES FOR RISK ASSESSMENT

(71) Applicants: International Business Machines Corporation, Armonk, NY (US); The Board of Trustees of the University of Illinois, Urbana, IL (US)

(72) Inventors: Kevin Ros, Bridgewater, NJ (US); Yu Deng, Yorktown Heights, NY (US); Larisa Shwartz, Greenwich, CT (US); Noah Zheutlin, White Plains, NY (US); Chengxiang Zhai, Champaign, IL (US)

(21) Appl. No.: 18/754,368

(22) Filed: Jun. 26, 2024

(51) Int. Cl. G06F 21/57

(52) U.S. Cl. CPC G06F 21/577; G06F 2221/034

(57) ABSTRACT

A computer-implemented method includes inputting a first input and a second input into a risk assessment machine learning model, such that, in response, the risk assessment machine learning model generates, as an output, a risk-based prediction associated with a change request (CR). The first input includes the CR, and the CR relates to a requested change for an information technology (IT) system. The second input includes a predicted set of documentation textual notes that would accompany implementation of the CR, the predicted set being generated as output from a generative language machine learning model in response to the CR being input into the generative language machine learning model.

### BACKGROUND

The present invention relates in general to programmable computers operable to implement deployment and management systems. More specifically, the present invention relates to computing systems, computer-implemented methods, and computer program products that utilize neural networks to predict the outcome of a proposed change (i.e., a change request). In some embodiments of the invention, the predicted change request outcome is used to enhance risk assessment operations.

A change request (CR) in software applications or hardware infrastructure configurations that execute the software (including cloud computing, etc.) is a formal proposal for a change to a system or product. CRs can include requests for additional features, customization, or service extensions, as well as changes to hardware infrastructure for example. CRs can also capture issues that require a response. CRs are typically described in a change record that documents the CR, including the desired change and its rationale. CRs can include information such as the change type, reason, priority, and date required. The change record can include a variety of information types, including but not limited to documentation of software deployment and development processes or infrastructure provisioning process; documentation of a risk assessment evaluation of potential changes; communications that keep IT, management, and end-users informed of system changes; and historical records that provide a running commentary on how the change implementation process has progressed over time.

### SUMMARY

Embodiments of the invention provide a computer-implemented method that includes inputting a first input and a second input into a risk assessment machine learning model, such that, in response, the risk assessment machine learning model generates, as an output, a risk-based prediction associated with a change request (CR). The first input includes the CR, and the CR relates to a requested change for an information technology (IT) system. The second input includes a predicted set of documentation textual notes that would accompany implementation of the CR, the predicted set being generated as output from a generative language machine learning model in response to the CR being input into the generative language machine learning model.

Embodiments of the invention are also directed to computer systems and computer program products having substantially the same features and functionality as the computer-implemented method described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts an exemplary computing environment operable to implement aspects of the invention;

FIG. 2A depicts a simplified block diagram illustrating a model of a biological neuron operable to be utilized in neural network (NN) architectures in accordance with aspects of the invention;

FIG. 2B depicts a simplified block diagram illustrating a deep learning NN architecture in accordance with aspects of the invention;

FIG. 3 depicts a diagram illustrating a non-limiting example of a dimensionality reduction operation operable to utilize word embeddings in accordance with aspects of the invention;

FIG. 4A depicts a simplified block diagram illustrating a non-limiting example of a transformer NN architecture operable to implement aspects of the invention;

FIG. 4B depicts a simplified block diagram illustrating a non-limiting example of an encoder element of a transformer NN architecture operable to implement aspects of the invention;

FIG. 4C depicts a simplified block diagram illustrating a non-limiting example of a decoder element of a transformer NN architecture operable to implement aspects of the invention;

FIG. 5A depicts a non-limiting example of a multi-field change record operable to be utilized in connection with aspects of the invention;

FIG. 5B depicts another non-limiting example of a multi-field change record operable to be utilized in connection with aspects of the invention;

FIG. 5C depicts another non-limiting example of a multi-field change record operable to be utilized in connection with aspects of the invention;

FIG. 6 depicts a non-limiting example of a language model and a risk assessment model operable to perform operations in accordance with aspects of the invention;

FIG. 7 depicts a non-limiting example of a language model operable to perform operations in accordance with aspects of the invention;

FIG. 8 depicts a non-limiting example of probabilistic language generation that can be used in the language model shown in FIG. 7;

FIG. 9A depicts a simplified block diagram illustrating a neural network architecture during a training or generation process in accordance with aspects of the invention;

FIG. 9B depicts a simplified block diagram illustrating a neural network architecture, post model training/generation, operable to perform tasks in accordance with aspects of the invention;

FIG. 9C depicts a simplified block diagram illustrating a neural network architecture, post model training/generation, operable to perform tasks in accordance with aspects of the invention;

FIG. 9D depicts a simplified block diagram illustrating a neural network architecture, post model training/generation, operable to perform tasks in accordance with aspects of the invention;

FIG. 10 depicts a risk assessment system operable to perform risk assessment operations in accordance with aspects of the invention; and

FIG. 11 depicts a non-limiting example of a risk assessment system operable to perform risk assessment operations in accordance with aspects of the invention; and

In the accompanying figures and following detailed description of the disclosed embodiments, the various elements illustrated in the figures are provided with three-digit reference numbers. In some instances, the leftmost digits of each reference number correspond to the figure in which its element is first illustrated.

### DETAILED DESCRIPTION

Turning now to a more detailed description of technologies that are more specifically related to aspects of the invention, the term “software” refers to the set of electronic program instructions or data a computer processor reads in order to perform a task or operation. There are two main categories of software, namely systems software and application software. Systems software includes the programs that are dedicated to managing the computer itself, such as the operating system, file management utilities, and disk operating system (or DOS). Application software enables the end-user to complete tasks such as creating documents, spreadsheets, databases, and publications; doing online research; sending email; designing graphics; running businesses; and even playing games. Application software can be installed locally on the end-user's computer or mobile device, or it can be stored on the cloud and accessed by any Internet-connected device. Application software is specific to the task for which it was designed and can be as simple as a calculator application or as complex as a word processing application. A web browser is an application specifically designed to locate, retrieve, and display content found on the Internet. By clicking a hyperlink or by typing the URL of a website, a user is able to view websites formed from one or more web pages.

A change record is a multi-field document or template used to keep track of, inter alia, the changes or “change requests” (CRs) that need to be executed in order for an application to work properly. A CR in software applications or hardware infrastructure configurations that execute the software (including cloud computing, etc.) is a formal proposal for a change to a system or product. The fields in a multi-field change record are used to capture issues, items or events, including but not limited to, a description of the proposed change(s); a purpose of the proposed change(s); where the proposed change will occur; how the proposed change is being applied; the entity or entities responsible for applying the proposed change; the entity or entities who requested the change; when the proposed change is being applied; a priority level of the requested change; and any sort of risk to customers, business and the like. After the proposed change is implemented, the change record is updated with information about the outcome(s) of the change, including, for example, progress made toward implementing the change; whether or not the proposed change worked; the portions of the proposed change that were successful; and the portions of the proposed change that were not successful. The field or fields of the change record capture information about the outcome(s) of the proposed change, which can include information on implementation progress made toward reaching the outcome(s). After a change record is created, it is still possible for implementation of a CR to cause an incident. In this case, an incident report is created, which in-part references the change record and associated CR that caused the incident, if applicable. For simplicity, we refer herein to the textual description of an outcome(s) of a CR as “close notes” (CN) or CN fields. This can include both notes added during the change deployment process and information from any created incident reports which reference the change.

Systems software, software applications, and related hardware infrastructure can change, including particularly software running on cloud platforms. Conventional software changes include software updates, fixing bugs, updating packages, and any sort of traditional developer processes. Infrastructure changes include updates of the operating system on which the software runs, provisioning additional computing or volume capacity. Changes are risky because they can cause outages that negatively impact customer trust, negatively impact business financials, and waste engineering time and resources. Because of these risks, resources are typically devoted to, before the change is implemented, assessing the risk of a proposed change. This assessment can help decision-making to reduce the likelihood that a selected course of action that might include the proposed change will negatively affect the systems in which the change will operate.

However, assessing the risk of a proposed change is a complex process and requires extensive engineering effort and time. More specifically, manual risk assessment of changes is difficult for a variety of reasons, including the large volume of change requests (e.g., 1000 to 10,000 CRs per month) that need to be evaluated for risk, as well as the lack of subject matter experts to perform manual risk evaluations. Efforts to automate the assessment of risk associated with a change are difficult because cognitive systems for assisting the risk assessment process are limited by a lack of sufficient training data for such cognitive systems.

Accordingly, there is a need for computer systems, computer-implemented methods, and computer program products configured and arranged to improve the efficiency and effectiveness of assessing the risk associated with a change.

Embodiments of the invention address the above-described need by providing computing systems, computer-implemented methods, and computer program products that utilize neural networks to predict the outcome, which includes utilizing the neural networks to predict the progress made on arriving at or implementing the outcome, of a proposed change (i.e., a change request). In some embodiments of the invention, the predicted change request outcome is used to enhance downstream risk assessment operations.

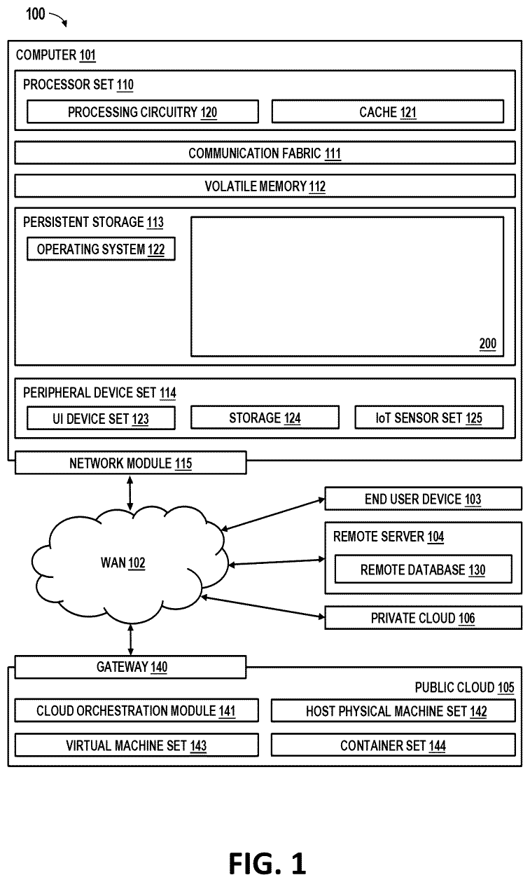

Some embodiments of the invention are implemented as a computer-implemented method that includes executing a risk assessment model operable to, responsive to a first input and a second input, determine an enhanced risk-based prediction associated with a change. As used herein, the term “executing” refers to a computing system (e.g., computing environment 100 shown in FIG. 1) loading and reading a set of electronic program instructions in order to perform a task or operation. The first input includes the CR, and the second input includes a predicted CR-implementation-progress associated with the CR.

In addition to any one or more of the features described herein, the predicted CR-implementation-progress is generated, based at least in part on the CR, using a generative language model.

In addition to any one or more of the features described herein, the generative language model has been trained based at least in part on historical change requests.

In addition to any one or more of the features described herein, the CR includes CR information of one or more CR fields of a multi-field change record.

In addition to any one or more of the features described herein, the enhanced risk-based prediction includes enhanced risk assessment (RA) information.

In addition to any one or more of the features described herein, the computer-implemented method further includes outputting the enhanced risk-based prediction and the predicted CR-implementation-progress to a display.

In addition to any one or more of the features described herein, the computer-implemented method further includes executing a risk assessment system operable to, responsive to the first input, the second input, a third input, and a fourth input, determine a further-enhanced risk-based prediction associated with a CR. The third input includes the enhanced risk-based prediction, and the fourth input includes output from a change record repository.

In embodiments of the invention, the above-described features and functionality can be implemented as a computer system and/or a computer program product.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together but can include disparate instructions stored in different locations which, when joined logically together, function as the module and achieve the stated purpose for the module.

The components/modules of the systems illustrated herein are depicted separately for ease of illustration and explanation. In embodiments of the invention, the functions performed by the components/modules can be distributed differently than shown without departing from the scope of the various embodiments of the invention describe herein unless it is specifically stated otherwise.

Various aspects of the present invention are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present invention to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present invention, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 1 depicts a computing environment 100 that contains an example of an environment for the execution of at least some of the computer code involved in performing the inventive methods, such as code block 200 operable to predict the outcome of a proposed change (i.e., a change request) to enhance downstream risk assessment operations. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Embodiments of the invention can be implemented using various forms of artificial intelligence (AI). In its simplest form, AI is a field that combines computer science and robust datasets to enable problem-solving. AI also encompasses sub-fields of machine learning and deep learning. Machine learning and deep learning are implemented as neural networks (NNs) having input layers, hidden layers and output layers. Machine learning NNs differ from deep learning NNs in that deep learning has more hidden layers than machine learning. AI systems can be implemented as AI algorithms that seek to create expert systems operable to make predictions or classifications based on input data.

Embodiments of the invention are further implemented using natural language processing (NLP), which is a branch of AI that gives machines the ability to understand natural human speech. Using linguistics, statistics, and machine learning, computers not only derive meaning from what is said or written, they can also understand contextual nuances and a speaker's or writer's intent and sentiment in substantially the same manner as humans.

Embodiment of the invention further leverage deep learning, which has been used extensively for perception tasks in NLP. For example, language models (LMs) can be implemented as transformer-based models that have advanced prediction and classification operations in various natural language tasks such as question answering, summarization, and language (or text) generation. Because the size of LMs can become quite large, they are often referred to as large language models (LLMs).

NNs used to implement aspects of the invention are a specific category of machines that can mimic human cognitive skills. In general, a NN is a network of artificial neurons or nodes inspired by the biological neural networks of the human brain. The artificial neurons/nodes of a NN are organized in layers and typically include input layers, hidden layers and output layers. Machine learning differ from deep learning in that deep learning has more hidden layers than machine learning. Neuromorphic and synaptronic systems, which are also referred to as artificial neural networks (ANNs), are computational systems that permit electronic systems to essentially function in a manner analogous to that of biological brains. Neuromorphic and synaptronic systems do not generally utilize the traditional digital model of manipulating zeros (0s) and ones (1s). Instead, neuromorphic and synaptronic systems create connections between processing elements that are roughly functionally equivalent to neurons of a biological brain. Neuromorphic and synaptronic systems can be implemented using various electronic circuits that are modeled on biological neurons.

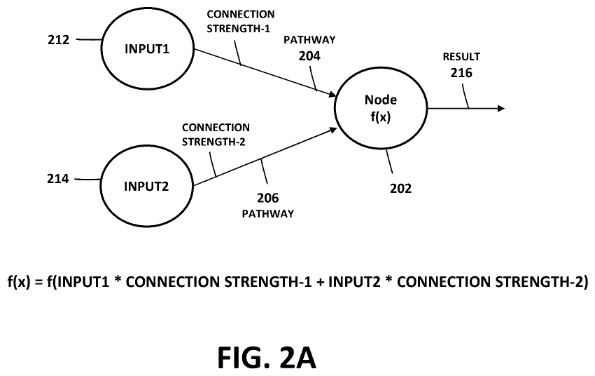

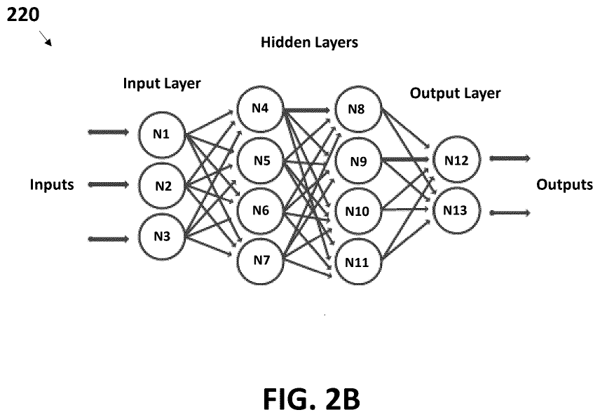

In FIG. 2A, the biological neuron is modeled as a node 202 having a mathematical function, f(x), depicted by the equation shown in FIG. 2A. Node 202 receives electrical signals from inputs 212, 214, multiplies each input 212, 214 by the strength of its respective connection pathway 204, 206, takes a sum of the inputs, passes the sum through a function, f(x), and generates a result 216, which may be a final output or an input to another node, or both. In the present specification, an asterisk (*) is used to represent a multiplication. Weak input signals are multiplied by a very small connection strength number, so the impact of a weak input signal on the function is very low. Similarly, strong input signals are multiplied by a higher connection strength number, so the impact of a strong input signal on the function is larger. The function f(x) is a design choice, and a variety of functions can be used. A suitable design choice for f(x) is the hyperbolic tangent function, which takes the function of the previous sum and outputs a number between minus one and plus one.

FIG. 2B depicts a simplified example of a deep learning NN architecture (or model) 220. In general, NNs can be implemented as a set of algorithms running on a programmable computer (e.g., computer 101 and/or remote server 104 of the computing environment 100 shown in FIG. 1). In some instances, NNs are implemented on an electronic neuromorphic machine (e.g., the IBM®/DARPA SyNAPSE computer chip) that attempts to create connections between processing elements that are substantially the functional equivalent of the synapse connections between brain neurons. In either implementation, NNs incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical). The basic function of a NN is to recognize patterns by interpreting sensory data through a kind of machine perception. Real-world data in its native form (e.g., images, sound, text, or time series data) is converted to a numerical form (e.g., a vector having magnitude and direction) that can be understood and manipulated by a computer. The NN is “trained” by performing multiple iterations of learning-based analysis on the real-world data vectors until patterns (or relationships) contained in the real-world data vectors are uncovered and learned.

NNs use feature extraction techniques to reduce the number of resources required to describe a large set of data. The analysis on complex data can increase in difficulty as the number of variables involved increases. Analyzing a large number of variables generally requires a large amount of memory and computation power. Additionally, having a large number of variables can also cause a classification algorithm to over-fit to training samples and generalize poorly to new samples. Feature extraction is a general term for methods of constructing combinations of the variables in order to work around these problems while still describing the data with sufficient accuracy.

Although the patterns uncovered/learned by a NN can be used to perform a variety of tasks, two of the more common tasks are labeling (or classification) of real-world data and determining the similarity between segments of real-world data. Classification tasks often depend on the use of labeled datasets to train the NN to recognize the correlation between labels and data. This is known as supervised learning. Examples of classification tasks include identifying objects in images (e.g., stop signs, pedestrians, lane markers, etc.), recognizing gestures in video, detecting voices, detecting voices in audio, identifying particular speakers, transcribing speech into text, and the like. Similarity tasks apply similarity techniques and (optionally) confidence levels (CLs) to determine a numerical representation of the similarity between a pair of items.

Returning again to FIG. 2B, the simplified NN architecture/model 220 is organized as a weighted directed graph, where the artificial neurons are nodes (e.g., N1-N13), and where weighted directed edges (i.e., directional arrows) connect the nodes. The NN architecture/model 220 is organized such that nodes N1, N2, N3 are input layer nodes, nodes N4, N5, N6, N7 are first hidden layer nodes, nodes N8, N9, N10, N11 are second hidden layer nodes, and nodes N12, N13 are output layer nodes. Having multiple hidden layers indicates that the NN architecture/model 220 is a deep learning NN architecture/model. Each node is connected to every node in the adjacent layer by connection pathways, which are depicted in FIG. 2B as directional arrows each having its own connection strength. For ease of illustration and explanation, one input layer, two hidden layers, and one output layer are shown in FIG. 2B. However, in practice, multiple input layers, multiple hidden layers, and multiple output layers can be provided. When multiple hidden layers are provided, the NN model 220 can perform unsupervised deep-learning for executing classification/similarity type tasks.

Similar to the functionality of a human brain, each input layer node N1, N2, N3 of the NN 220 receives Inputs directly from a source (not shown) with no connection strength adjustments and no node summations. Each of the input layer nodes N1, N2, N3 applies its own internal f(x). Each of the first hidden layer nodes N4, N5, N6, N7 receives its inputs from all input layer nodes N1, N2, N3 according to the connection strengths associated with the relevant connection pathways. Thus, in first hidden layer node N4, its function is a weighted sum of the functions applied at input layer nodes N1, N2, N3, where the weight is the connection strength of the associated pathway into the first hidden layer node N4. A similar connection strength multiplication and node summation is performed for the remaining first hidden layer nodes N5, N6, N7, the second hidden layer nodes N8, N9, N10, N11, and the output layer nodes N12, N13.

The NN model 220 can be implemented as a feedforward NN or a recurrent NN. A feedforward NN is characterized by the direction of the flow of information between its layers. In a feedforward NN, information flow is unidirectional, which means the information in the model flows in only one direction—forward—from the input nodes, through the hidden nodes (if any) and to the output nodes, without any cycles or loops. In contrast to recurrent NNs, which have a bi-directional information flow, feedforward NNs are trained using the backpropagation method.

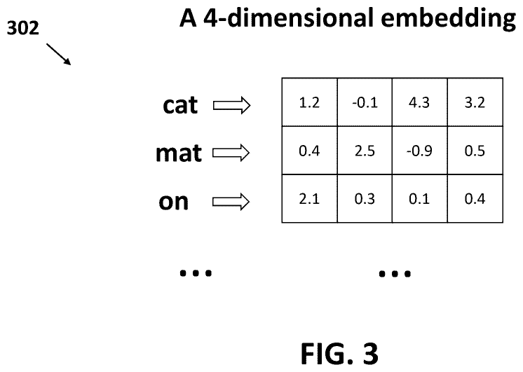

Some embodiments of the invention utilize and leverage embedding spaces. An embedding is a relatively low-dimensional space into which high-dimensional vectors can be translated. Embeddings make it easier to apply machine learning to large inputs like sparse vectors representing words. FIG. 3 illustrates the concept of embedding using an example word embedding 302. In general, NN models take vectors (i.e., an array of numbers) as inputs. Where the inputs are natural language symbols, token/word vectorization refers to techniques that extract information from the natural language symbol corpus and associate to each word of the natural language symbol corpus a vector using a suitable vectorization algorithm that takes into account the word's context.

Word embeddings are typically a low-dimensional dense vector-based space where the semantically similar words are placed closely together. In general, an embedding is a dense vector of floating-point values. In a word embedding, words are represented by dense vectors where a vector represents the projection of the word into a continuous vector space. The dimension of the vector is a parameter that must be specified. However, the values of the embeddings are trainable parameters (i.e., weights learned by the model during training in the same way a model learns weights for a dense layer). More specifically, the position of a word within the vector space of an embedding is learned from text in the relevant language domain and is based on the words that surround the word when it is used. The position of a word in the learned vector space of the word embedding is referred to as its embedding.

FIG. 3 depicts an example diagram of a word embedding 302 in an English language domain. As shown in FIG. 3, each word is represented as a 4-dimensional vector of floating-point values. Another way to think of the word embedding 302 is as a “lookup table.” After the weights have been learned, each word can be encoded by looking up the dense vector it corresponds to in the table. The embedding layer (or lookup table) maps from integer indices (which stand for specific words) to dense vectors (their embeddings). The dimensionality (or width) of the embedding is a parameter that can be selected to match the task for which it is designed. When an embedding layer is created, the weights for the embeddings are randomly initialized (just like any other layer), During training, the weights are gradually adjusted via back-propagation training techniques. Once trained, the learned word embeddings will roughly encode similarities between words (as they were learned for the specific problem on which the model is trained). The general techniques used in word embedding apply to embeddings in other domains, including domains used in embodiments of the invention.

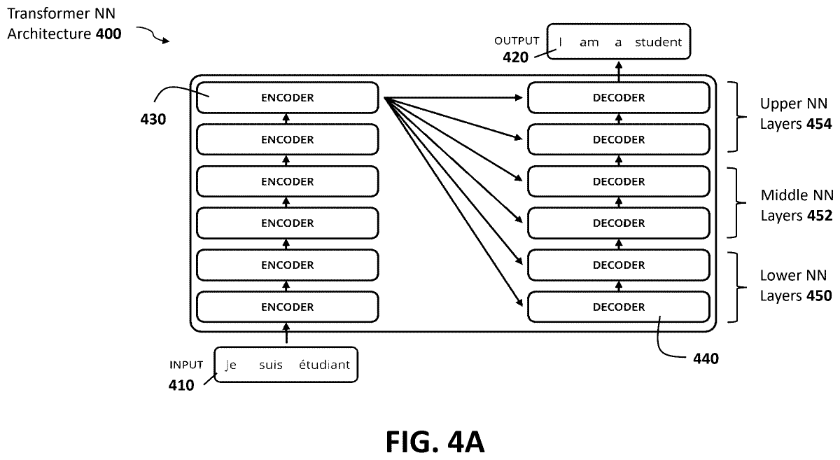

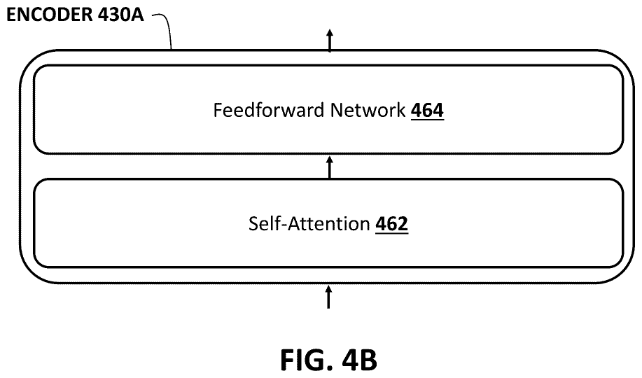

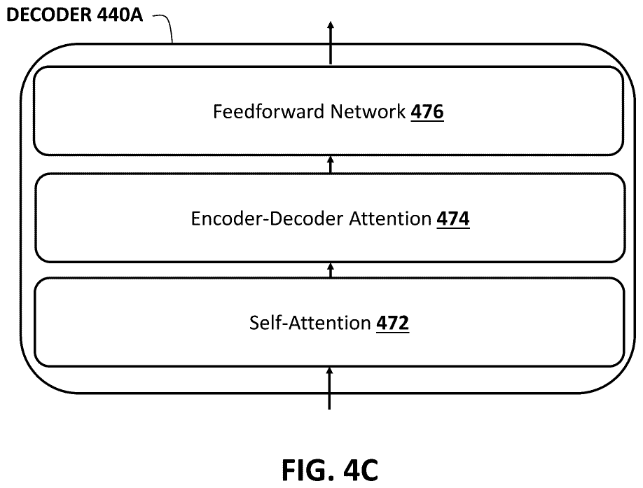

FIGS. 4A, 4B and 4C depict a non-limiting example of various aspects of a transformer NN architecture 400 that can be utilized to implement some aspects of the invention. More specifically, FIG. 4A depicts a simplified block diagram illustrating a non-limiting example of the transformer NN architecture 400; FIG. 4B depicts a simplified block diagram illustrating a non-limiting example of an encoder 430A of the transformer NN architecture 400; and FIG. 4C depicts a simplified block diagram illustrating a non-limiting example of a decoder 440A of the transformer NN architecture 400.

The transformer NN architecture 400 includes tokenization and embedding features. In embodiments of the invention, the transformer NN architecture 400 converts text and other data to vectors and back using tokenization, positional encoding, and embedding layers. Tokenization is the process of splitting a phrase, sentence, paragraph, one or multiple text documents into smaller units. Each of these smaller units is called a token. In general, tokens can be anything, including, for example, a word, a sub-word, or even a character. Multiple types of algorithms are available for performing tokenization. The transformer NN architecture 400 is a sequence-to-sequence NN architecture in which input text is encoded with tokenizers to sequences of integers called input tokens. Input tokens are mapped to sequences of vectors (e.g., word embeddings) via embeddings layers. Output vectors (embeddings) can be classified to a sequence of tokens, and output tokens can then be decoded back to text.

More generally, tokenization is cutting input data into parts (symbols) that can be mapped (embedded) into a vector space. For example, input text is split into frequent words, which is an example of transformer tokenization. Tokenization used in transformer-based NLP models can be sub-word tokenizers. The resulting tokens can be both words or “sub-words” In some instances, special tokens can be appended to the sequence (e.g., class tokens) used for classification embeddings. Positional encodings add token order information. Self-attention and feed-forward layers are symmetrical with respect to the input so positional information is provided about each input token so positional encodings or embeddings are added to token embeddings in transformer encodings. Accordingly, embeddings are learned and/or trained.

As shown in FIG. 4A, the transformer NN architecture 400 includes a series or sequence of encoders 430 and a sequence of decoders 440 configured and arranged as shown. The encoders 430 and decoders 440 are organized around groups of layers including lower NN layers 450, middle NN layers 452, and upper NN layers 454. The transformer NN architecture 400 receives an input 410 (e.g., a sentence in French), uses the encoders 430 and the decoders 440 to perform a task (e.g., translating a French sentence to an English sentence), and, responsive to the input 410 generates an output 420 (e.g., an English translation of a French sentence). More specifically, the encoders 430 are configured and arranged to take the input 410, for example a sentence (i.e., sequences) written in French, and mapping it to high-dimensional representation(s). The encoders 430 are configured to “learn” the parts of the input 410 (i.e., the sequence) that are important and pass them to the high-dimensional representation, and the less-important aspects of the input 410 (e.g., the sequence) are left out. At this stage, the high-dimensional representation cannot be easily understood because there are no semantics involved and the complete mapping has not yet been learned.

The decoders 440 are configured to convert the high-dimensional representation into the output 420, which, in this example, is a sequence (e.g., a sequence written in English). Utilizing the encoders 430 and the decoders 440 allows models to be built that can transduce (i.e., map without losing semantics) “one way” into “another,” e.g., French into English. By training the encoders 430 and the decoders 440 together, a sequence-to-sequence model is created. A sequence-to-sequence model is capable of ingesting (e.g., using data translation processes to convert data/information into a form that is machine-readable) a sequence of a particular kind and outputting another sequence of another kind.

In embodiments of the invention, the transformer NN architecture 400 (also known as a generative language model) can be trained to perform the various tasks described herein. In the transformer NN architecture 400, the encoders 430 can be organized in layers (e.g., lower NN layers 450, middle NN layers 452, and upper NN layers 454) that process the input 410 iteratively one layer after another; and the decoders 440 can also be organized in corresponding layers (e.g., lower NN layers 450, middle NN layers 452, and upper NN layers 454) that do the same thing to the output of the last encoder 430. The function of each encoder 430 in a given layer is to process its input to generate encodings that contain information about which parts of the inputs are relevant to each other. The encoder 430 in one layer passes its set of encodings to the encoder 430 in the next layer as inputs. Each decoder 440 in a corresponding layer does the opposite, taking the output from the last encoder 430 and processing them, using their incorporated contextual information, to generate the output 420. To achieve this, each encoder 430 of a given layer makes use of an attention mechanism (e.g., self-attention 462 shown in FIG. 4B). In the context of NNs, an attention mechanism is a technique that electronically mimics human cognitive attention. The effect enhances the important parts of the input data and fades out the rest such that the NN devotes more computing power on that small but important part of the data. The part of the data that is more important than other parts of the data depends on the context and is learned through training data by gradient descent. Thus, the attention mechanism of the transformer NN architecture 400 weighs the relevance of every other input and draws information from them accordingly to produce the output. Each decoder 440 can include an additional attention mechanism (e.g., self-attention 472 and encoder-decoder attention 474 shown in FIG. 4C) that draws information from the outputs of previous decoders 440 before the current decoder 440 draws information from the encodings. The encoders 430 and the decoders 440 each include a feedforward network (e.g., feedforward network 464 shown in FIG. 4B, and feedforward network 476 shown in FIG. 4C) for additional processing of the outputs, and also contain residual connections and layer normalization steps.

FIG. 4B depicts a simplified block diagram illustrating a non-limiting example of how the encoder 430 (shown in FIG. 4A) can be implemented as the encoder 430A; and FIG. 4C depicts a simplified block diagram illustrating a non-limiting example of how the decoder 440 (shown in FIG. 4A) can be implemented as the decoder 440A. The encoders 430 are very similar to each other, and the decoders 440 are very similar to each other, as well. As shown in FIG. 4B, each encoder 430A includes two sub-layers, namely, a self-attention 462 and a feedforward network 464. The inputs to the encoder 430A first flow through the self-attention 462, which helps the encoder 430A look at other parts of the input 410 as it encodes a specific word. The decoder 440A shown in FIG. 4C has a corresponding self-attention 472 and feedforward network 476 that perform substantially the same functions in the decoder 440A as the self-attention 462 and the feedforward network 464 perform in the encoder 430A. The decoder 440A further includes encoder-decoder attention 474 that helps the decoder 440A focus on relevant parts of the input sentence.

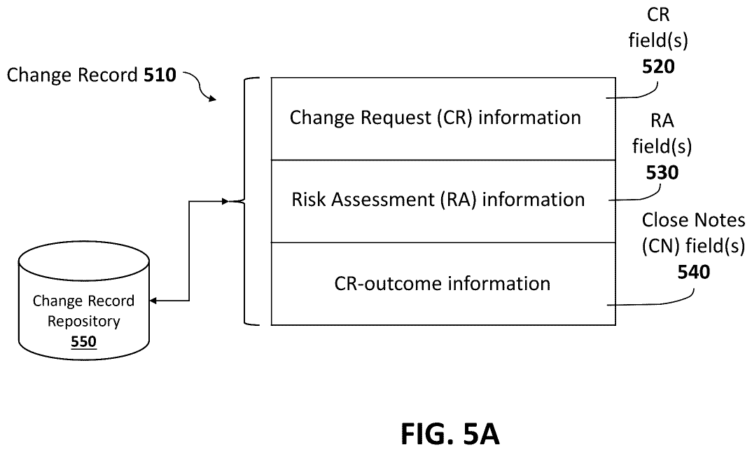

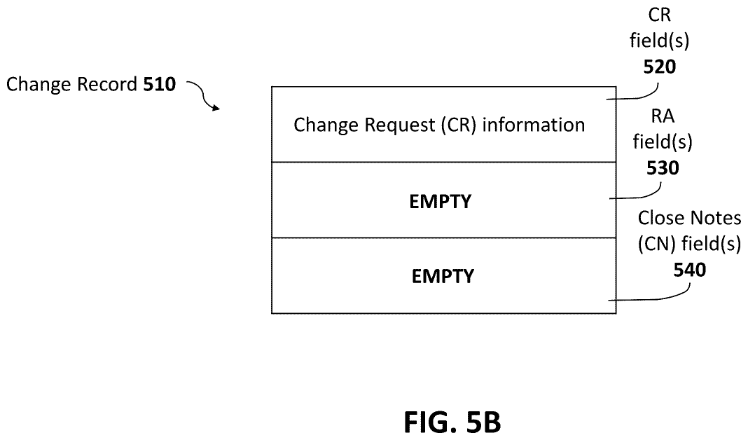

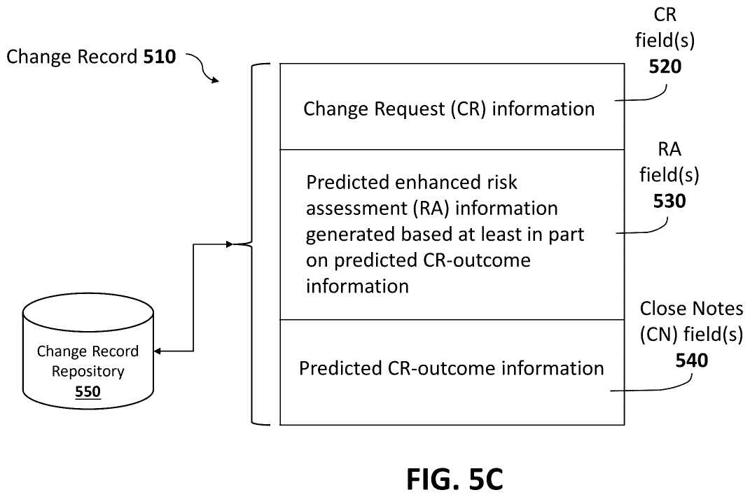

Turning now to a more detailed description of aspects of the invention, FIG. 5A depicts a non-limiting example of a multi-field change record, which is represented in FIG. 5A as change record 510. In embodiments of the invention, the change record 510 is electronically stored in a computing environment (e.g., computing environment 100 shown in FIG. 1) in computer memory storage and operable to be utilized in connection with aspects of the invention. The change record 510 includes one or more instances of a CR field 520, one or more instances of a Risk Assessment (RA) field 530, and one or more instances of a “close notes” (CN) field 540. The change record 510 is implemented as an electronic document or template, and the CR field(s) 520 of the change record 510 are used to store CR information that keeps track of, inter alia, the changes or change requests that need to be executed in order for an application to work properly. The fields 520, 530, 540 in the change record 510 are used to capture information about items or events, including but not limited to, a description of the proposed change(s); where the proposed change will occur; how the proposed change is being applied; the entity or entities responsible for applying the proposed change; when the proposed change is being applied; and an assessment of the likelihood of any sort of risk to customers, business and the like. The RA information can take a variety of forms, including, for example, a natural language (NL) description of the RA and/or a numerical representation of the RA generated by a trained RA machine learning model. After the proposed change is implemented, the CN field(s) 540 of the change record 510 are updated with information about the outcome(s) of the change, including, for example, progress made toward implementing the change; whether or not the proposed change worked; the portions of the proposed change that were successful; and the portions of the proposed change that were not successful. The one or more instances of the CR field 520 of the change record 510 capture information about the outcome(s) of the proposed change, which can include information on implementation progress made toward reaching the outcome(s). After change record 510 is created, it is still possible for implementation of a CR to cause an incident. In this case, an incident report is created, which in-part references the change record 510 and associated CR that caused the incident, if applicable. For simplicity, we refer herein to the textual description of an outcome(s) of a CR as “close notes” (CN) or CN field(s) 540. This can include both notes added during the change deployment process and information from any created incident reports which reference the change. Should there be an issue with the change after it is closed, an incident report is created that contains a reference to the change, along with a description of the incident caused by the change. The information stored in the change record 510 can be generated using conventional methodologies without the enhancements provided by the systems and methodologies of embodiments of the invention disclosed herein.

The change record 510 can be stored in a change record repository 550. The change record repository 550 can be implemented using any suitable structure that facilitates the storage and retrieval of electronic information/data. In some embodiments of the invention, the change record repository 550 can be implemented as a searchable database that organizes and stores electronic data/information of change record 510 in segments or regions of the change record repository 550. The change record repository 550 can be any form of database, including but not limited to, relational SQL databases, noSQL unstructured databases, unstructured data lakes, time-series databases, and the like. In some embodiments, the change record repository 550 can include features and functionality of a relational database operably controlled by the computing environment 100 (shown in FIG. 1). In general, a database is a means of storing information in such a way that information can be retrieved from it, and a relational database presents information in tables with rows and columns. A table is referred to as a relational table in the sense that it is a collection of objects of the same type (rows). Data in a table can be related according to common keys or concepts, and the ability to retrieve related data from a table is the basis for the term relational database. A database management system (DBMS) of the computing environment 100 controls the way data in the change records 510 in the change record repository 550 are stored, maintained, and retrieved. A DBMS of the computing environment 100 performs the tasks of determining the way data and other information are stored, maintained, and retrieved from the change record repository 550.

FIG. 5B depicts the change record 510 after the CR information has been developed (e.g., by a subject matter expert) and electronically stored in the CR field 520. However, at this stage, a risk assessment has not yet been performed, and the CR has not yet been implemented. Hence, as shown in FIG. 5B, the RA field 530 and the CN field 540 are empty. Embodiments of the invention, as described subsequently herein, provide methodologies and systems for enhancing RA information and enhancing CR-outcome information that is developed and ultimately stored in the RA field 530 and the CN field 540, respectively, thereby improving the efficiency and effectiveness of assessing the risk associated with a CR.

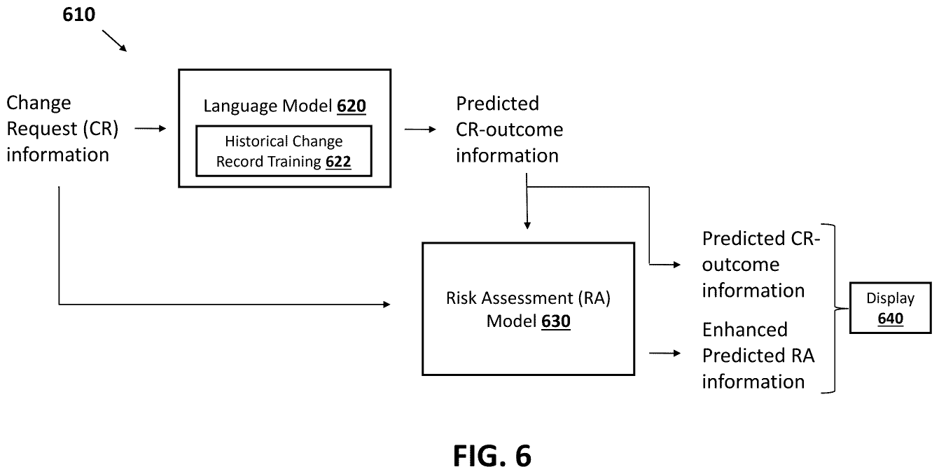

FIG. 5C depicts the change record 510 after embodiments of the invention, as described subsequently herein, have applied methodologies and systems (e.g., the system 610 shown in FIG. 6) to the CR information. The methodologies and systems applied to the CR information generate predicted CR-outcome information, which can include information on implementation progress made toward reaching the outcome (i.e., CR-implementation-progress). The methodologies and systems applied to the CR information further generate predicted enhanced RA information based at least in part on the predicted CR-outcome information. The predicted RA information is “enhanced” in that the methodologies and systems applied to the CR information in accordance with embodiments of the invention generate RA information in a manner that considers the predicted CR-outcome information, which provides better information for making a prediction of the RA assessment information. Like the instance of the change record 510 shown in FIG. 5A, the instance of the change record 510 shown in FIG. 5C can be stored in the change record repository 550. In some embodiments, a change request is considered to be risky if an incident log exists that expressly references the change request. In some embodiments, a change request is considered to not be risky if no incident log exists that references that change request. In some instances, the change records 510 that are stored in the change record repository 550 include a binary label of one (1) risky or zero (0) not risky.

FIG. 6 depicts a non-limiting example of a system 610 embodying aspects of the invention. The system 610 includes a language machine learning model (LM) 620 and an RA machine learning model 630, configured and arranged as shown. In accordance with embodiments of the invention, historical change record training 622 has been applied to the LM 620 using, for example, historical change records in the change record repository 550 (shown in FIGS. 5A and/or 5B). The historical change record training 622 uses LM training techniques to train the LM 620 to ingest (e.g., use data translation processes to convert data/information into a form that is machine-readable) CR information as an input, and then generate therefrom an output that includes a prediction of the CR-outcome information (i.e., predicted CR-outcome information) associated with the CR information. The historical records include sets of change requests and historical close notes textual information produced while implementing, reviewing, and/or evaluating the change requests. In some embodiments of the invention, the close notes textual information is produced by one or more subject matter experts, or produced at the direction of one or more subject matter experts. The historical close notes textual information acts as ground truth labels in the set of training data. The LM 620 has its weights adjusted during the training 622 so that the LM 620 learns to predict/generate a set of historical close notes textual information in response to receiving a particular change request as an input. The predicted CR-outcome information includes machine generated NL information about the outcome of the change in the CR, including, for example, whether or not the proposed change worked; the portions of the proposed change that were successful; the portions of the proposed change that were not successful; and the like.

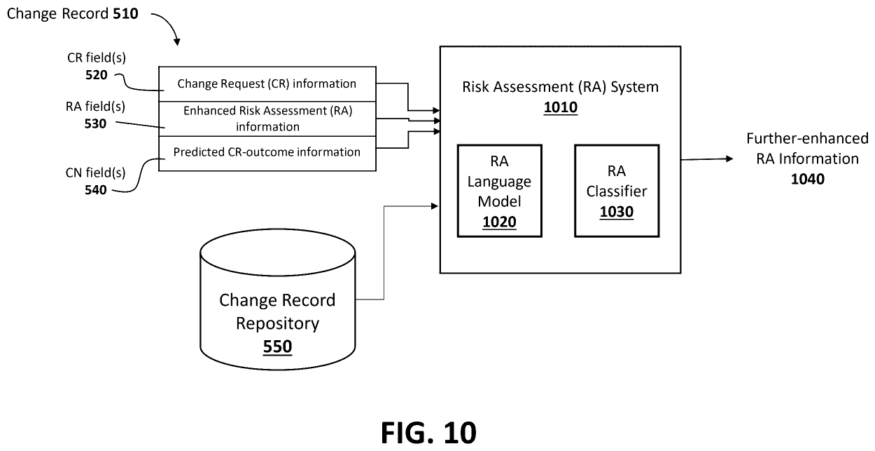

Referring still to FIG. 6, the CR information and the predicted CR-outcome information are provided as inputs to the RA model 630, which has been trained to output, in response to the inputs, a prediction of the RA information associated with the CR information. The RA model 630 can be implemented as an LM trained to evaluate a NL change request and generate an assessment (in NL or numerical) of the risk associated with the NL change request. An RA model that generates a NL risk assessment can be implemented as an encoder-decoder LM; and an RA model that generates a numerical representation (e.g., a number from zero to one) of the NL risk assessment can be implemented as an encoder-based LM that ingests NL (e.g., uses data translation processes to convert data/information into a form that is machine-readable) and outputs a number. In the system 610, the RA model 630 is enhanced or augmented by both the CR information and the predicted CR-outcome information being provided to the RA model 630 as inputs. The system 610 outputs the predicted CR-outcome information and the enhanced predicted RA information, both of which are sent to a display 640 and presented at the display 640 of a computer (e.g., visually, audibly, and/or tactilely). A subject matter expert can review the predicted CR-outcome information and the enhanced predicted RA information on the display 640 to be assisted in evaluating the risks associated with CRs prior to implementing the CR. In some embodiments of the invention, as described in greater detail subsequently herein, the predicted CR-outcome information and the enhanced predicted RA information can be further processed (e.g., using RA system 1010 shown in FIG. 10) to generate further-enhanced RA information 1040 to even further assist the subject matter expert in evaluating the risks associated with CRs prior to implementing the CR. Like the instances of the change record 510 shown in FIGS. 5A and 5C, the further-enhanced RA information 1040 can be added to an instance of the change record 510 and stored in the change record repository 550.

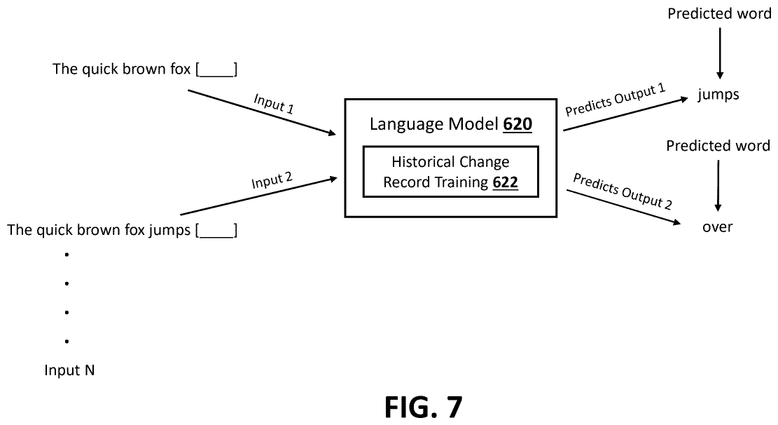

FIG. 7 depicts additional details of how the LM 620 is implemented in accordance with aspects of certain embodiments of the invention. In some embodiments of the invention, the LM 620 is a generative transformer-based LM operable to perform advanced prediction and classification operations in various natural language tasks such as question answering, summarization, and language (e.g., text) generation. In some embodiments of the invention, the LM 620 can be sufficiently large to qualify as a large language model (LLM). An evolution of language models has resulted in LLMs, which dramatically expand the data used for training and inference, and which provide a massive increase in the capabilities of the resulting model. While there is no universally accepted figure for how large the data set for training needs to be, an LLM typically has about one billion or more parameters. Parameters are a machine learning term for the variables present in the model on which it was trained that can be used to infer new content. An LLM uses deep learning techniques and massively large data sets to understand, summarize, generate and predict new content. The term generative AI also is closely connected with LMs and/or LLMs, which are a type of generative AI that has been specifically architected to help generate language-based content. References herein to LMs include implementations of the LMs that qualify as LLMs.

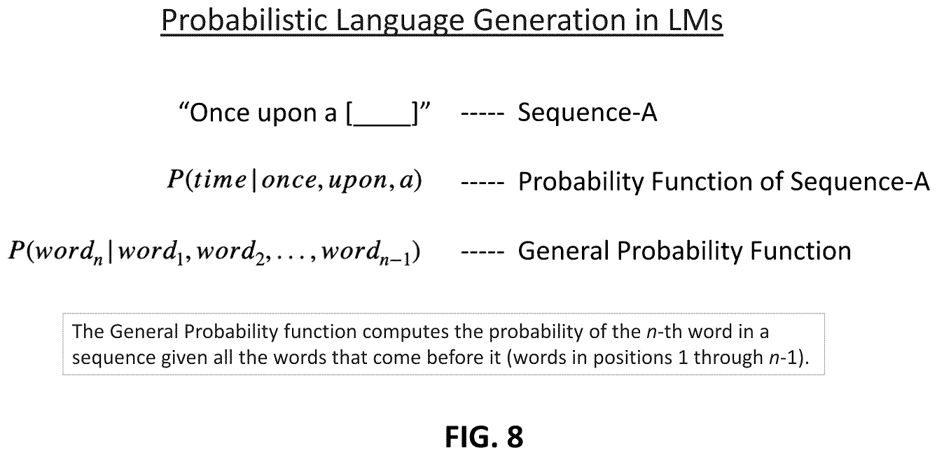

A non-limiting example of generative text operations that can be performed by the LM 620 is illustrated in FIG. 7. As shown, Input 1 is a sequence of tokens or words that form a segment of a sentence (in the depicted example Input 1 is a partial sentence “The quick brown fox”), and the LM 620 has been trained to predict the next word in the sentence segment, or, when the sentence is complete, predict the next sentence in the overall text. The LM 620 uses, for example, the encoder-decoder and self-attention functionality of the transformer NN architecture 400 (shown in FIGS. 4A, 4B, 4C) to predict Output 1, which is a prediction that the next token/word in Input 1 is “jumps.” The encoder-decoder functionality and self-attention functionality of the transformer NN architecture 400 perform various forms of probabilistic language generation, an example of which is the general probability function, P(wordₙ|word₁, word₂, . . . , wordₙ₋₁), shown in FIG. 8. The general probability function computes the probability of the n-th word in a sequence given all the words that come before it (words in positions 1 through n−1). Continuing with FIG. 7, the LM 620 appends the predicted word “jumps” to Input 1 to generate Input 2, and Input 2 is provided to the LM 620, which then uses Input 2 to predict Output 2, which is a prediction that the next token/word in Input 2 is “over.” This process of predicting next words continues until the desired text content is complete (i.e., Input N).

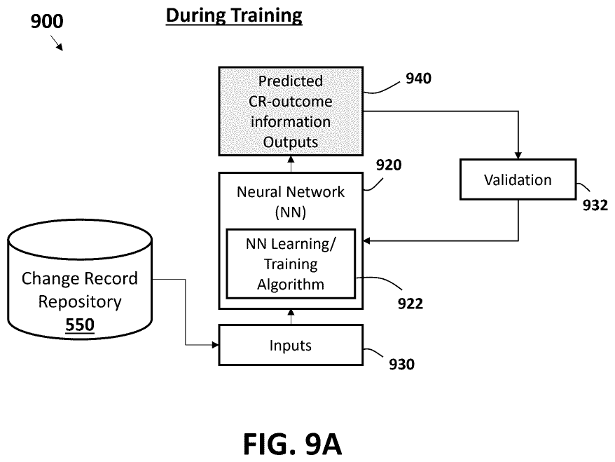

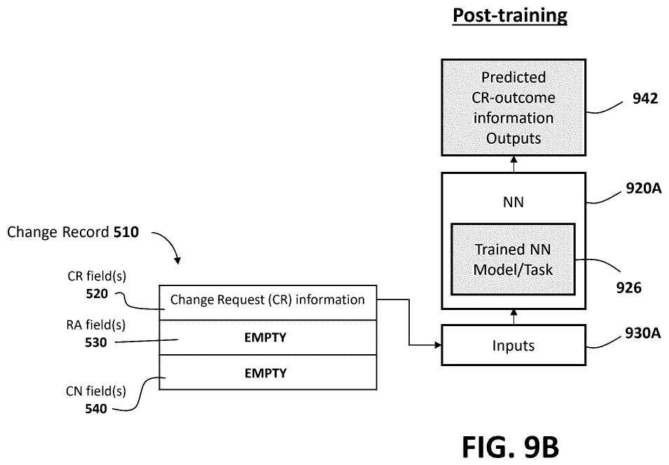

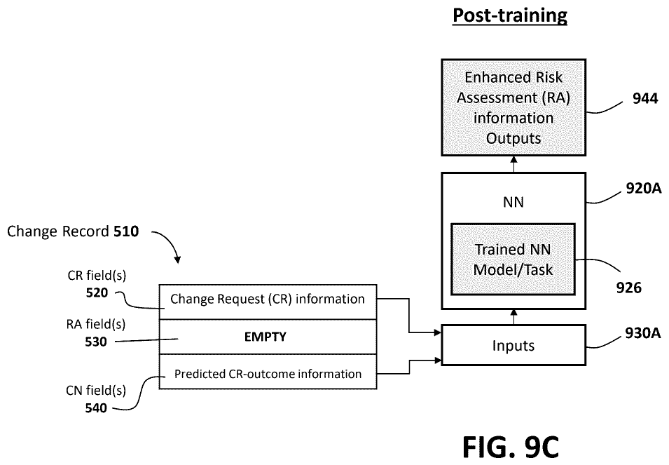

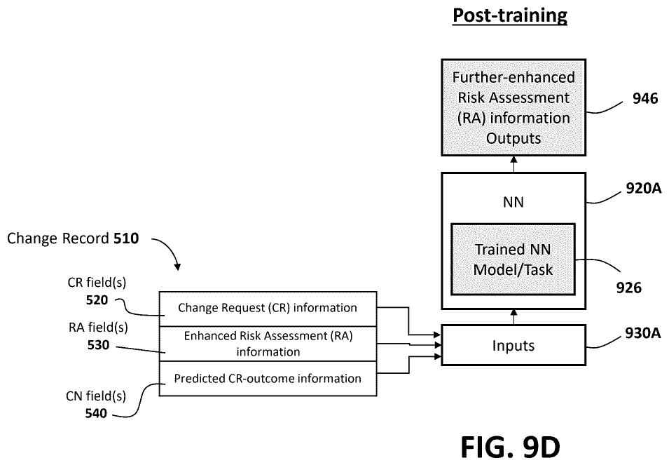

FIG. 9A depicts a simplified block diagram of a system 900 operable to train/generate a NN 920 in accordance with aspects of the invention. The NN 920 is a non-limiting example of how the LM 620 can be implemented in accordance with embodiments of the invention. In embodiments of the invention, the NN 920 is a pre-trained foundation model that has been pretrained on a large corpus of NL training data. Thus, the training operations shown in FIG. 9A are tuning operations applied to a pre-trained foundation model implementation of the NN 920. Training/generation can be performed by a NN learning/training algorithm 922 of the NN 920 and involves selecting the best weight and bias values to achieve the accuracy of the resulting trained NN model/task 926 (shown in FIG. 9B) on a training data that includes various instances of the change records 510 (e.g., as depicted in FIGS. 5A, 5C, 9D, 10), which can be stored in the change record repository 550. The training data is generated by retrieving historical records from the change record repository 550 and includes sets of change requests, historical close notes textual information associated with a particular change request, and RA information. In some instances, the RA information includes textual information produced by or under the supervision of one or more subject matter experts. The historical close notes textual information and the RA textual information act as ground truth labels in the set of training data. The LM 620 has its weights adjusted, e.g., via backpropagation, during the training 622 so that the LM 620 learns to predict/generate a set of historical close notes textual information in response to receiving a particular change request as an input. Other portions of the historical records are used as the validation set 932 that is used to monitor the performance of the NN 920. In an evaluation step, the performance of the trained model/task (e.g., trained NN model/task 926 shown in FIG. 9B) is evaluated on a test set. The test set is used to measure the generalization performance of the new model/task. If the new model/task performs well on the test set, the training is considered sufficient so that the trained neural network 920 can be deployed in a production environment.

As shown in FIG. 9A, in accordance with embodiments of the invention, the inputs 930 are various forms of the change records 510 retrieved from the change record repository 550; the NN learning/training algorithm 922 is any suitable learning methodology for training the NN 920; and the outputs 940 are predicted CR-outcome information outputs 940 generated by NN 920 during training and/or tuning. As shown, the training operation performed by the system 900 includes supplying the inputs 930 to the NN 920, and applying the NN learning/training algorithm 922 to the inputs 930 to generate the predicted CR-outcome information outputs 940.

FIG. 9B depicts a NN 920A, post-training, which is the NN 920 (shown in FIG. 9A) after the training/generation has been completed. The NN 920A is obtained via performance of the training shown in FIG. 9A and includes a trained NN model/task 926. In accordance with embodiments of the invention, the trained NN model/task 926 in some embodiments includes the LM 620 having historical change record training 622 (shown in FIG. 6). In response to inputs 930A, the trained NN model/task 926 generates predicted CR-outcome information outputs 942 in accordance with aspects of the invention. In FIG. 9B, the inputs 930A are the CR information taken from the instance of the change record 510 shown in FIG. 5B.

FIG. 9C depicts another instance of the NN 920A, post-training, which is the NN 920 (shown in FIG. 9A) after the training/generation has been completed. The NN 920A is obtained via performance of a different instance of the training shown in FIG. 9A and includes a trained NN model/task 926. In accordance with embodiments of the invention, the trained NN model/task 926 is the RA model 630 (shown in FIG. 6). In response to inputs 930A, the trained NN model/task 926 generates predicted enhanced RA information outputs 944 in accordance with aspects of the invention. In FIG. 9C, the inputs 930A are the CR information (e.g., received as an initial CR) and the predicted CR-outcome information (e.g., produced in the process shown in FIG. 9B), which can be stored in and retrieved from an instance of the change record 510.

FIG. 9D depicts another instance of the NN 920A, post-training, which is the NN 920 (shown in FIG. 9A) after the training/generation has been completed. The NN 920A is obtained via performance of a different instance of the training shown in FIG. 9A and includes a trained NN model/task 926. In accordance with embodiments of the invention, the trained NN model/task 926 is used to implement portions of an RA system (e.g., the RA system 1010 shown in FIG. 10). In response to inputs 930A, the trained NN model/task 926 generates predicted further-enhanced RA information outputs 946 in accordance with aspects of the invention. In FIG. 9C, the inputs 930A are the CR information, the predicted enhanced RA information, and the predicted CR-outcome information, which can be stored in and retrieved from an instance of the change record 510.

FIG. 10 depicts an RA system 1010 in accordance with embodiments of the invention. The RA system 1010 includes any suitable configuration of RA language models 1020 and RA classifiers 1030 operable to ingest CR information, enhanced RA information, predicted CR-outcome information, and change records from the change record repository 550 to generate the further-enhanced RA information 1040. In embodiments of the invention, the enhanced RA information and the predicted CR-outcome information are generated using the system 610 shown in FIG. 6. The RA language models 1020 perform generative language model operations to ingest the various relevant NL inputs to the RA system 1010 to generate NL versions of the further-enhanced RA information 1040; and the RA classifiers (e.g., encoder-based language models) perform generative language model operations to ingest the various relevant NL inputs to the RA system 1010 to generate numerical versions (e.g., a number from zero (0) to one (1) representing a prediction of the risk associated with the CR information) of the further-enhanced RA information 1040. Thus, in accordance with embodiments of the invention, the RA system 1010 generates multiple versions of the further-enhanced RA information 1040 in any combination of NL and/or numerical representations. In accordance with embodiments of the invention, the further-enhanced RA information 1040 is “further-enhanced” because the efficiency and effectiveness of outputs generated by the RA system 1010 are improved by configuring the RA system 1010 such that it takes into account the enhanced RA information and/or the predicted CR-outcome information.

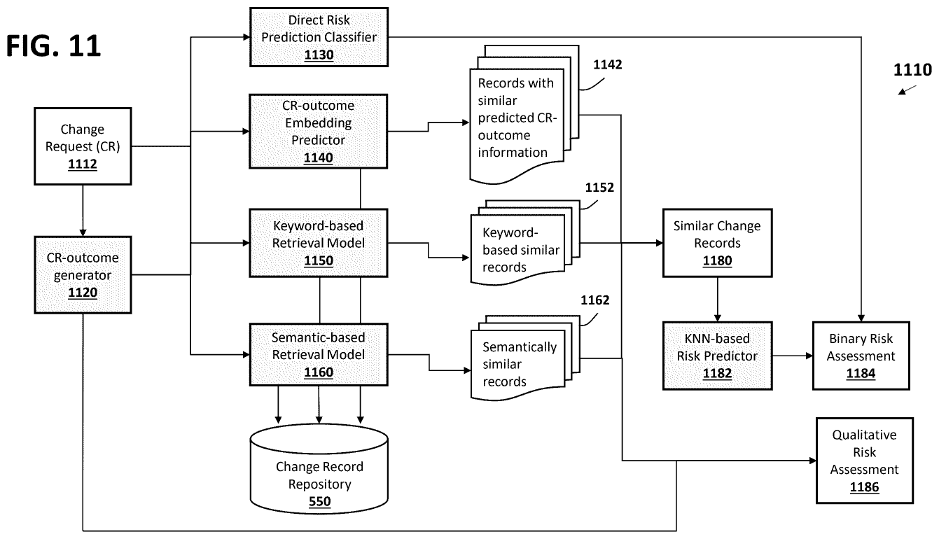

FIG. 11 depicts an RA system 1110 in accordance with embodiments of the invention. The RA system 1110 includes a CR-outcome generator 1120, a direct risk prediction classifier 1130, a CR-outcome embedding predictor 1140, a keyword-based retrieval model 1150, a semantic-based retrieval model 1160, and a KNN-based (k-nearest neighbors) risk predictor 1182, configured and arranged as shown. A CR 1112 is provided to the direct risk prediction classifier 1130, the CR-outcome embedding predictor 1140, the keyword-based retrieval model 1150, and/or the semantic-based retrieval model 1160. The CR-outcome generator 1120, responsive to the CR 1112, generates a predicted CR-outcome associated with the CR and passes the predicted CR-outcome to the direct risk prediction classifier 1130, the CR-outcome embedding predictor 1140, the keyword-based retrieval model 1150, and/or the semantic-based retrieval model 1160. The CR-outcome generator 1120 can be implemented as the LM 620 (shown in FIG. 6), and the direct risk prediction classifier 1130 can be implemented as an encoder-based implementation of the RA model 630 (shown in FIG. 6). The direct risk prediction classifier 1130 generates enhanced RA information and provides this output as the binary risk assessment 1184. The CR-outcome embedding predictor 1140 can be implemented as an encoder-only language model 430A (shown in FIG. 4B) and is operable to use the CR 1112 and the predicted CR-outcome to measure the semantic similarity to historical records saved in change record repository 550, thereby retrieving the records with similar predicted CR-outcome information 1142. The keyword-based retrieval model 1150 can be implemented as a BM25 (BM=best matching) information retrieval system, which is a ranking function used by search engines to estimate the relevance of documents to a given search query. It is based on the probabilistic retrieval framework The keyword-based retrieval model 1150 is operable to use the CR 1112 and the predicted CR-outcome to compare the keyword overlap to historical records saved in Change Record Repository 550, thereby retrieving the keyword-based similar records 1142. The semantic-based retrieval model 1160 can be implemented as an encoder-only language model 430A (shown in FIG. 4B) and is operable to use the CR 1112 and the predicted CR-outcome to measure the semantic similarity to historical records saved in change record repository 550, thereby generating semantically similar records 1162. The records 1142, 1152, and 1162 are aggregated into similar change records 1180. The KNN-based risk predictor 1182 receives the similar change records 1180 and is configured to aggregate the risky and non-risky outcomes from the retrieved historical change records from 1140, 1150, and 1160. The aggregation acts as a vote where, if the majority of the retrieved records are labeled as “risky,” then the label of “risky” is provided as the binary risk assessment 1184. Otherwise, if the majority are non-risky, then the label of “non-risky” is provided as the binary risk assessment 1184. The binary risk assessment 1184 in various embodiments includes two distinct risk predictions: (1) e the aggregated risky/non-risky label from the KNN-based risk predictor 1182 and (2) the risky/non-risky prediction from the direct risk prediction classifier 1130. The qualitative risk assessment 1186, the first binary risk prediction, and/or the second binary risk prediction are presented via a computer, e.g., via a user interface that displays the predictions visually, plays the predictions audibly via a speaker connected to (in a wired or wireless manner) the computer, and/or presents the predictions via a tactile-feedback device. These predictions contain the output from the CR-outcome generator 1120. Here, the end user is provided with the generated outcome given the CR 1112. The user interface is configured to present the two distinct risk predictions from both the KNN-based risk predictor 1182 and the direct risk prediction classifier 1130 as well as to present the qualitative risk assessment 1186. In other embodiments, separate user interfaces are provided for the binary and qualitative risk assessments.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The terminology used herein is for the purpose of describing particular embodiments of the invention only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

It will be understood that those skilled in the art, both now and in the future, may make various improvements and enhancements which fall within the scope of the claims which follow.

What is claimed is:

1. A computer-implemented method comprising:
inputting a first input and a second input into a risk assessment machine learning model, such that, in response, the risk assessment machine learning model generates, as an output, a risk-based prediction associated with a change request (CR);
wherein the first input comprises the CR and the CR relates to a requested change for an information technology (IT) system; and
wherein the second input comprises a predicted set of documentation textual notes that would accompany implementation of the CR, the predicted set being generated as output from a generative language machine learning model in response to the CR being input into the generative language machine learning model.

2. The computer-implemented method of claim 1, wherein the generative language machine learning model has been trained based at least in part on historical change records comprising change requests and sets of documentation textual notes that were associated with the historical change requests.

3. The computer-implemented method of claim 1 further comprising presenting, via a computer, at least one of the risk-based prediction and the predicted set of documentation textual notes.

4. The computer-implemented method of claim 1 further comprising:
executing a risk assessment system operable to, responsive to the first input, the second input, a third input, and a fourth input, determine a further-enhanced risk-based prediction associated with the CR;
wherein the third input comprises the risk-based prediction; and
wherein the fourth input comprises an output from a change record repository.

5. The computer-implemented method of claim 1, wherein the risk assessment machine learning model comprises a generative language machine learning model.

6. The computer-implemented method of claim 5, wherein the generative language machine learning model comprises an encoder.

7. The computer-implemented method of claim 1, wherein the risk-based prediction comprises a numerical value that represents a predicted risk of implementing the requested change.

8. The computer-implemented method of claim 1, wherein the CR comprises at least one of natural language and programming language.

9. The computer-implemented method of claim 1, wherein the predicted set of documentation textual notes include at least one member selected from a group consisting of:
progress made toward implementing the change;
whether or not the proposed change worked;
the portions of the proposed change that were successful; and
the portions of the proposed change that were not successful.

10. The computer-implemented method of claim 1, wherein the CR comprises at least one member selected from a group consisting of:
a textual description of the requested change;
a location within the IT system at which the requested change will occur;
how the requested change is being applied;
one or more entities responsible for applying the requested change;
when the requested change is scheduled to be applied;
a purpose of the requested change;
one or more entities who requested the requested change; and
a priority level of the requested change.

11. A computer system comprising a processor system and a memory electronically coupled to the processor system, wherein the processor system is operable to perform processor system operations comprising:
inputting a first input and a second input into a risk assessment machine learning model, such that, in response, the risk assessment machine learning model generates, as an output, a risk-based prediction associated with a change request (CR);
wherein the first input comprises the CR and the CR relates to a requested change for an information technology (IT) system; and
wherein the second input comprises a predicted set of documentation textual notes that would accompany implementation of the CR, the predicted set being generated as output from a generative language machine learning model in response to the CR being input into the generative language machine learning model.

12. The computer system of claim 11, wherein the generative language machine learning model has been trained based at least in part on historical change records comprising change requests and sets of documentation textual notes that were associated with the historical change requests.

13. The computer system of claim 11, wherein the processor operations further comprise presenting, via a computer, at least one of the risk-based prediction and the predicted set of documentation textual notes.

14. The computer system of claim 11, wherein the processor operations further comprise:
executing a risk assessment system operable to, responsive to the first input, the second input, a third input, and a fourth input, determine a further-enhanced risk-based prediction associated with the CR;
wherein the third input comprises the risk-based prediction; and
wherein the fourth input comprises an output from a change record repository.

15. The computer system of claim 11, wherein:
the risk assessment machine learning model comprises a generative language machine learning model; and
the generative language machine learning model comprises an encoder.

16. The computer system of claim 11, wherein the risk-based prediction comprises a numerical value that represents a predicted risk of implementing the requested change.

17. The computer system of claim 11, wherein the CR comprises at least one of natural language and programming language.

18. The computer system of claim 11, wherein the predicted set of documentation textual notes include at least one member selected from a group consisting of:
progress made toward implementing the change;
whether or not the proposed change worked;
the portions of the proposed change that were successful; and
the portions of the proposed change that were not successful.

19. The computer system of claim 11, wherein the CR comprises at least one member selected from a group consisting of:
a textual description of the requested change;
a location within the IT system at which the requested change will occur;
how the requested change is being applied;
one or more entities responsible for applying the requested change;
when the requested change is scheduled to be applied;
a purpose of the requested change;
one or more entities who requested the requested change; and
a priority level of the requested change.

20. A computer program product comprising a computer readable storage medium storing program instructions operable to instruct a processor system to perform processor system operations comprising:
inputting a first input and a second input into a risk assessment machine learning model, such that, in response, the risk assessment machine learning model generates, as an output, a risk-based prediction associated with a change request (CR);
wherein the first input comprises the CR and the CR relates to a requested change for an information technology (IT) system; and
wherein the second input comprises a predicted set of documentation textual notes that would accompany implementation of the CR, the predicted set being generated as output from a generative language machine learning model in response to the CR being input into the generative language machine learning model.
